(19) United States
(12) Patent Application Publication
(10) Pub. No.: US 2007/0129528 A1
(43) Pub. Date: Jun. 7, 2007

(54) Two-part curable composition and polyurethane-polysiloxane resin mixture obtained therefrom

(76) Inventors: Misty Huang, New City, NY (US); David A. Williams, Gansevoort, NY (US)

Correspondence Address: DILWORTH & BARRESE, LLP, 333 EARLE OVINGTON BLVD., SUITE 702, UNIONDALE, NY, 11553, US

(21) Appl. No.: 11/292,026

(22) Filed: Dec. 1, 2005

(51) Int. Cl. C08G 18/00

(52) U.S. Cl. 528/78

(57) ABSTRACT

A substantially uniform polyurethane-polysiloxane resin mixture is obtained from a two-part curable composition in which the first part contains a moisture-curable silylated polyurethane resin and a crosslinker for silanol-terminated diorganopolysiloxane, the second part contains silanol-terminated diorganopolysiloxane and a condensation catalyst is present in the first and/or second part.

### BACKGROUND OF THE INVENTION

This invention relates to a two-part room temperature curable, storage-stable composition which on combination of the two parts undergoes rapid curing to provide a polyurethane-polysiloxane resin mixture.

Polysiloxanes (silicones) and polyurethanes possess very different, but highly useful, physical and mechanical properties which have led to their widespread use in countless applications. Attempts have been made to provide a single composition exhibiting the desirable properties of both types of resin but thus far are believed to have been largely unsuccessful. While copolymers of polysiloxanes and polyurethanes are known, they are considered to be difficult and costly to manufacture. Uniform physical blends of polysiloxanes and polyurethanes have also been difficult to achieve due to the highly incompatible properties of these resins and their pronounced tendency to undergo phase separation following their initial admixture.

### SUMMARY OF THE INVENTION

In accordance with the present invention, a two-part curable composition which is stable during storage as two parts and on their combination cures to provide a substantially uniform polyurethane-polysiloxane resin mixture, the composition comprising:
a) a substantially moisture-free first part comprising moisture-curable silylated polyurethane resin and crosslinker for the crosslinking of silanol-terminated diorganopolysiloxane;
b) a second part comprising silanol-terminated diorganopolysiloxane;
c) a condensation catalyst in the first and/or second part; and, optionally,
d) at least one additional component selected from the group consisting of filler, UV stabilizer, antioxidant, adhesion promoter, cure accelerator, thixotropic agent, plasticizer, moisture scavenger, pigment, dye, surfactant, solvent and biocide, the additional component being present in the first part and/or second part, whichever part(s) the component is compatible therewith.

The expression “substantially uniform polyurethane-polysiloxane resin mixture” as used herein refers to a resinous composition containing moisture-cured, i.e., hydrolyzed and subsequently crosslinked, silylated polyurethane (SPU) resin in intimate admixture with crosslinked silanol-terminated diorganopolysiloxane (SDPS) resin, the composition in bulk exhibiting substantially uniform mechanical properties throughout. While it is not understood at this time precisely how or in what manner the crosslinked SPU resin and crosslinked SDPS resins are associated with each other in the resin mixture, it is believed, subject to later scientific demonstration, that the association involves few, if any, covalent bonds between the two resins.

Owing to the substantially homogeneous nature of the polyurethane-polysiloxane hybrid resin of this invention, the resin exhibits excellent physical properties, e.g., high modulus and high tensile strength which are typical characteristics of the crosslinked SPU resin component of the resin mixture and good weatherability and high thermostability which are typical characteristics of the crosslinked SDPS component of the hybrid resin.

### DETAILED DESCRIPTION OF THE INVENTION

The substantially uniform polyurethane-polysiloxane resin mixture of the present invention is obtained by combining, i.e., admixing, the two-part curable composition as hereinafter more fully described. The two parts constituting the curable composition, respectively, the “first part” and the “second part”, while separated from each other exhibit storage stability of an indefinite duration but once combined, undergo rapid cure to provide the resin mixture herein.

A. The First Part of the Curable Composition

The first part of the two-part curable composition herein contains a silylated polyurethane (SPU) resin, a crosslinker for diorganopolysiloxane wherein the silicon atom at each polymer chain end is silanol terminated (“silanol-terminated diorganopolysiloxane”, or SDPS) and, optionally, one or more other ingredients by which the overall curable composition may be adapted to function as a sealant, adhesive or coating as desired.

Moisture-curable silylated polyurethanes which can be employed in the first part of the curable composition are known materials and in general can be obtained by (a) reacting an isocyanate-terminated polyurethane (PU) prepolymer with a suitable silane, e.g., one possessing both hydrolyzable functionality, specifically, one to three alkoxy groups for each silicon atom, and active hydrogen functionality, e.g., mercapto, primary amine and, advantageously, secondary amine, which is reactive for isocyanate, or by (b) reacting a hydroxyl-terminated PU prepolymer with a suitable isocyanate-terminated silane, e.g., one possessing one to three alkoxy groups. The details of these reactions, and those for preparing the isocyanate-terminated and hydroxyl-terminated PU prepolymers employed therein can be found in, amongst others: U.S. Pat. Nos. 4,985,491, 5,919,888, 6,197,912, 6,207,794, 6,303,731, 6,359,101 and 6,515,164 and published U.S. Patent Application Nos. 2004/0122253 and 2005/0020706 (isocyanate-terminated PU prepolymers); U.S. Pat. Nos. 3,786,081 and 4,481,367 (hydroxyl-terminated PU prepolymers); U.S. Pat. Nos. 3,627,722, 3,632,557, 3,971,751, 5,623,044, 5,852,137, 6,197,912, 6,207,783 and 6,310,170 (moisture-curable SPU resin obtained from reaction of isocyanate-terminated PU prepolymer and reactive silane, e.g., aminoalkoxysilane); and, U.S. Pat. Nos. 4,345,053, 4,625,012, 6,833,423 and published U.S. Patent Application 2002/0198352 (moisture-curable SPU resin obtained from reaction of hydroxyl-terminated PU prepolymer and isocyanatosilane). The entire contents of the foregoing U.S. patent documents are incorporated by reference herein.

(a) Moisture-curable SPUR Resin Obtained From Isocyanate-terminated PUR Prepolymer

The isocyanate-terminated PU prepolymers are obtained by reacting one or more polyols, advantageously, diols, with one or more polyisocyanates, advantageously, diisocyanates, in such proportions that the resulting prepolymers will be terminated with isocyanate. In the case of reacting a diol with a diisocyanate, a molar excess of diisocyanate will be employed.

Included among the polyols that can be utilized for the preparation of the isocyanate-terminated PU prepolymer are polyether polyols, polyester polyols such as the hydroxyl-terminated polycaprolactones, polyetherester polyols such as those obtained from the reaction of polyether polyol with e-caprolactone, polyesterether polyols such as those obtained from the reaction of hydroxyl-terminated polycaprolactones with one or more alkylene oxides such as ethylene oxide and propylene oxide, hydroxyl-terminated polybutadienes, and the like.

Specific suitable polyols include the poly(oxyalkylene)ether diols (i.e., polyether diols), in particular, the poly(oxyethylene)ether diols, the poly(oxypropylene)ether diols and the poly(oxyethylene-oxypropylene)ether diols, poly(oxyalkylene)ether triols, poly(tetramethylene)ether glycols, polyacetals, polyhydroxy polyacrylates, polyhydroxy polyester amides, polyhydroxy polythioethers, polycaprolactone diols and triols, and the like. In one embodiment of the present invention, the polyols used in the production of the isocyanate-terminated PU prepolymers are poly(oxyethylene)ether diols with equivalent weights between about 500 and 25,000. In another embodiment of the present invention, the polyols used in the production of the isocyanate-terminated PU prepolymers are poly(oxypropylene)ether diols with equivalent weights between about 1,000 to 20,000. Mixtures of polyols of various structures, molecular weights and/or functionalities can also be used.

The polyether polyols can have a functionality up to about 8 but advantageously have a functionality of from 2 to 4 and more advantageously, a functionality of 2 (i.e., diols). Especially suitable are the polyether polyols prepared in the presence of double-metal cyanide (DMC) catalysts, an alkaline metal hydroxide catalyst, or an alkaline metal alkoxide catalyst; see, for example, U.S. Pat. Nos. 3,829,505, 3,941,849, 4,242,490, 4,335,188, 4,687,851, 4,985,491, 5,096,993, 5,100,997, 5,106,874, 5,116,931, 5,136,010, 5,185,420 and 5,266,681, the entire contents of which are incorporated here by reference. Polyether polyols produced in the presence of such catalysts tend to have high molecular weights and low levels of unsaturation, properties of which, it is believed, are responsible for the improved performance of inventive retroreflective articles. The polyether polyols preferably have a number average molecular weight of from about 1,000 to about 25,000, more preferably from about 2,000 to about 20,000, and even more preferably from about 4,000 to about 18,000. Examples of commercially available diols that are suitable for making the isocyanate-terminated PU prepolymer include ARCOL R-1819 (number average molecular weight of 8,000), E-2204 (number average molecular weight of 4,000), and ARCOL E-2211 (number average molecular weight of 11,000).

Any of numerous polyisocyanates, advantageously, diisocyanates, and mixtures thereof, can be used to provide the isocyanate-terminated PU prepolymers. In one embodiment, the polyisocyanate can be diphenylmethane diisocyanate (“MDI”), polymethylene polyphenylisocyanate (“PMDI”), paraphenylene diisocyanate, naphthylene diisocyanate, liquid carbodiimide-modified MDI and derivatives thereof, isophorone diisocyanate, dicyclohexylmethane-4,4′-diisocyanate, toluene diisocyanate (“TDI”), particularly the 2,6-TDI isomer, as well as various other aliphatic and aromatic polyisocyanates that are well-established in the art, and combinations thereof.

Silylation reactants for reaction with the isocyanate-terminated PUR prepolymers described above must contain functionality that is reactive with isocyanate and at least one readily hydrolyzable and subsequently crosslinkable group, e.g., alkoxy. Particularly useful silylation reactants are the silanes of the general formula:
X—R¹—Si(R²)ₓ(OR³)₃₋ₓ
wherein X is an active hydrogen-containing group that is reactive for isocyanate, e.g., —SH or —NHR⁴ in which R⁴ is H, a monovalent hydrocarbon group of up to 8 carbon atoms or —R⁵—Si(R⁶)_{y}(OR⁷)_{3-y}, R¹ and R⁵ each is the same or different divalent hydrocarbon group of up to 12 carbon atoms, optionally containing one or more heteroatoms, each R² and R⁶ is the same or different monovalent hydrocarbon group of up to 8 carbon atoms, each R³ and R⁷ is the same or different alkyl group of up to 6 carbon atoms and x and y each, independently, is 0, 1 or 2.

Specific silanes for use herein include the mercaptosilanes 2-mercaptoethyl trimethoxysilane, 3-mercaptopropyl trimethoxysilane, 2-mercaptopropyl triethoxysilane, 3-mercaptopropyl triethoxysilane, 2-mercaptoethyl tripropoxysilane, 2-mercaptoethyl tri sec-butoxysilane, 3-mercaptopropyl tri-t-butoxysilane, 3-mercaptopropyl triisopropoxysilane, 3-mercaptopropyl trioctoxysilane, 2-mercaptoethyl tri-2′-ethylhexoxysilane, 2-mercaptoethyl dimethoxy ethoxysilane, 3-mercaptopropyl methoxyethoxypropoxysilane, 3-mercaptopropyl dimethoxy methylsilane, 3-mercaptopropyl methoxy dimethylsilane, 3-mercaptopropyl ethoxy dimethylsilane, 3-mercaptopropyl diethoxy methylsilane, 3-mercaptopropyl cyclohexoxy dimethyl silane, 4-mercaptobutyl trimethoxysilane, 3-mercapto-3-methylpropyltrimethoxysilane, 3-mercapto-3-methylpropyl-tripropoxysilane, 3-mercapto-3-ethylpropyl-dimethoxy methylsilane, 3-mercapto-2-methylpropyl trimethoxysilane, 3-mercapto-2-methylpropyl dimethoxyphenylsilane, 3-mercaptocyclohexyl-trimethoxysilane, 12-mercaptododecyl trimethoxy silane, 12-mercaptododecyl triethoxy silane, 18-mercaptooctadecyl trimethoxysilane, 18-mercaptooctadecyl methoxydimethylsilane, 2-mercapto-2-methylethyl-tripropoxysilane, 2-mercapto-2-methylethyl-trioctoxysilane, 2-mercaptophenyl trimethoxysilane, 2-mercaptophenyl triethoxysilane, 2-mercaptotolyl trimethoxysilane, 2-mercaptotolyl triethoxysilane, 1-mercaptomethyltolyl trimethoxysilane, 1-mercaptomethyltolyl triethoxysilane, 2-mercaptoethylphenyl trimethoxysilane, 2-mercaptoethyiphenyl triethoxysilane, 2-mercaptoethyltolyl trimethoxysilane, 2-mercaptoethyltolyl triethoxysilane, 3-mercaptopropylphenyl trimethoxysilane and, 3-mercaptopropylphenyl triethoxysilane, and the aminosilanes 3-aminopropyltrimethoxysilane, 3-aminopropyltriethoxysilane, 4-aminobutyltriethoxysilane, N-methyl-3-amino-2-methylpropyltrimethoxysilane, N-ethyl-3-amino-2-methylpropyltrimethoxysilane, N-ethyl-3-amino-2-methylpropyldiethoxymethylsilane, N-ethyl-3-amino-2-methylpropyltriethoxysilane, N-ethyl-3-amino-2-methylpropylmethyldimethoxysilane, N-butyl-3-amino-2-methylpropyltrimethoxysilane, 3-(N-methyl-2-amino-1-methyl-1-ethoxy)-propyltrimethoxysilane, N-ethyl-4-amino-3,3-dimethyl-butyldimethoxymethylsilane, N-ethyl-4-amino-3,3-dimethylbutyltrimethoxy-silane, N-(cyclohexyl)-3-aminopropyltrimethoxysilane, N-(2-aminoethyl)-3-aminopropyltrimethoxysilane, N-(2-aminoethyl)-3-aminopropyltriethoxy-silane, N-(2-aminoethyl)-3-aminopropylmethyldimethoxysilane, aminopropyltriethoxysilane, bis-(3-trimethoxysilyl-2-methylpropyl)amine and N-(3′-trimethoxysilylpropyl)-3-amino-2-methylpropyltrimethoxysilane.

A catalyst will ordinarily be used in the preparation of the isocyanate-terminated PU prepolymers. Advantageously, condensation catalysts are employed since these will also catalyze the cure (hydrolysis followed by crosslinking) of the SPU resin component of the curable compositions of the invention. Suitable condensation catalysts include the dialkyltin dicarboxylates such as dibutyltin dilaurate and dibutyltin acetate, tertiary amines, the stannous salts of carboxylic acids, such as stannous octoate and stannous acetate, and the like. In one embodiment of the present invention, dibutyltin dilaurate catalyst is used in the production of the PUR prepolymer. Other useful catalysts include zirconium-containing and bismuth-containing complexes such as KAT XC6212, K-KAT XC-A209 and K-KAT 348, supplied by King Industries, Inc., aluminum chelates such as the TYZER® types, available from DuPont company, and the KR types, available from Kenrich Petrochemical, Inc., and other organometallic catalysts, e.g., those containing a metal such as Zn, Co, Ni, Fe, and the like.

(b) Moisture-curable SPUR Resins Obtained From Hydroxyl-terminated PUR Prepolymers

The moisture-curable SPU resin of the first part of the curable composition of the invention can, as previously indicated, be prepared by reacting a hydroxyl-terminated PU prepolymer with an isocyanatosilane. The hydroxyl-terminated PU prepolymer can be obtained in substantially the same manner employing substantially the same materials, i.e., polyols, polyisocyanates and optional catalysts (preferably condensation catalysts), described above for the preparation of isocyanate-terminated PU prepolymers the one major difference being that the proportions of polyol and polyisocyanate will be such as to result in hydroxyl-termination in the resulting prepolymer. Thus, e.g., in the case of a diol and a diisocyanate, a molar excess of the former will be used thereby resulting in hydroxyl-terminated PU prepolymer.

Useful silylation reactants for the hydroxyl-terminated SPU resins are those containing isocyanate termination and readily hydrolizable functionality, e.g., 1 to 3 alkoxy groups. Suitable silylating reactants are the isocyanatosilanes of the general formula: 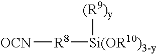
wherein R⁸ is an alkylene group of up to 12 carbon atoms, optionally containing one or more heteroatoms, each R⁹ is the same or different alkyl or aryl group of up to 8 carbon atoms, each R¹⁰ is the same or different alkyl group of up to 6 carbon atoms and y is 0, 1 or 2. In one embodiment, R⁸ possesses 1 to 4 carbon atoms, each R¹⁰ is the same or different methyl, ethyl, propyl or isopropyl group and y is 0.

Specific isocyanatosilanes that can be used herein to react with the foregoing hydroxyl-terminated PU prepolymers to provide moisture-curable SPU resins include isocyanatopropyltrimethoxysilane, isocyanatoisopropyl trimethoxysilane, isocyanato-n-butyltrimethoxysilane, isocyanato-t-butyltrimethoxysilane, isocyanatopropyltriethoxysilane, isocyanatoisopropyltriethoxysilane, isocyanato-n-butyltriethoxysilane, isocyanato-t-butyltriethoxysilane, and the like.

(c) Crosslinker

The crosslinker component in the first part of the curable composition is one which is effective for the crosslinking of silanol-terminated diorganopolysiloxane (SDPS), the latter being a component of the second part of the curable composition. In one embodiment, the crosslinker is an alkylsilicate of the general formula:
(R¹¹O)(R¹²O)(R¹³O)(T¹⁴O)Si
where R¹¹, R¹², R¹³ and R¹⁴ are independently chosen monovalent hydrocarbon radicals of up to about 60 carbon atoms.

Crosslinkers useful herein include tetra-N-propylsilicate (NPS), tetraethylorthosilicate, methytrimethoxysilane and similar alkyl substituted alkoxysilane compositions.

B. The Second Part of the Curable Composition

The silanol-terminated diorganopolysiloxane polymer (SDPS) in the second part of the curable composition is advantageously selected from amongst those of the general formula:
MₐD_{b}D′_{c}
with the subscript a=2 and b equal to or greater than 1 and with the subscript c zero or positive where
M=(HO)_{3-x-y}R¹⁵ₓR¹⁶_{y}SiO_{1/2};
with the subscript x=0, 1 or 2 and the subscript y is either 0 or 1, subject to the limitation that x+y is less than or equal to 2, where R¹⁵ and R¹⁶ are independently chosen monovalent C₁ to C₆₀ hydrocarbon radicals; where
D=R¹⁷R¹⁸SiO_{1/2};
where R¹⁷ and R¹⁸ are independently chosen monovalent C₁ to C₆₀ hydrocarbon radicals; where
D′=R¹⁹R²⁰SiO_{2/2};
where R¹⁹ and R²⁰ are independently chosen monovalent hydrocarbon radicals of up to about 60 carbon atoms.

The foregoing SDPS polymer and their crosslinking with alkylsilicate crosslinkers such as those described above are disclosed in further detail in published U.S. Patent Application 2005/0192387, the entire contents of which are incorporated by reference herein

C. Optional Ingredients

Optionally, the first and/or second part of the curable composition can contain one or more additional ingredients, e.g., filler, UV stabilizer, antioxidant, adhesion promoter, cure accelerator, thixotropic agent, plasticizer, moisture scavenger, pigment, dye, surfactant, solvent and biocide, the additional component being present in the first part and/or second part, whichever part(s) the component is compatible therewith. Thus, e.g., filler, where present, can be in the first and/or second part; U.V. stabilizer where present, will ordinarily be in the first part; antioxidant, where present will ordinarily be in the first part; adhesion promoter, where present, will be in the first part; cure accelerator, where present, will usually be in the second part; thixotropic agent, where present, will generally be included in the first part; plasticizer, where present, is in the first and/or second part; moisture scavenger, where present, will be in the first part; pigment, where present, can be in the first and/or second part; dye, where present, can be in the first and/or second part; surfactant, where present, can be in the first and/or second part; solvent, where present, can be in the first and/or second part; and, biocide, where present, will be incorporated generally in the second part.

The following examples are illustrative of the two-part curable composition of the invention and the substantially uniform polyurethane-polysiloxane resin mixture obtained therefrom.

### EXAMPLE 1

This example illustrates the preparation of a moisture-curable SPU resin derived from the reaction of an isocyanate-terminated PU prepolymer and an aminosilane. The SPU resin was used in making the first part of the two-part compositions of Examples 2-5 and the one-part composition of Comparative Example 1.

The SPU resin was made in a two-step reaction sequence substantially as described in U.S. Pat. No. 6,602,964, the entire contents of which are incorporated by reference herein. In the first stage, isocyanate-terminated PU prepolymer was made by reacting a polypropylene ether diol (Acclaim 4200, 400 g) with isophorone diisocyanate (IPDI, 34.8 g) in the presence of a trace amount of tin catalyst (dibutyltin dilaurate, 3.5 ppm). The prepolymer-forming reaction was carried out at 70-75° C. until the concentration of NCO dropped to 0.8% as measured by titration. In the second stage (silylation of the prepolymer), 17.6 g of N-isobutylaminopropyl-trimethoxysilane was added to the prepolymer to react with all of the remaining NCO until no NCO was detectable by titration. The resulting moisture-curable SPU resin had a viscosity of about 100,000 cps at 25° C.

### COMPARATIVE EXAMPLE 1; EXAMPLES 2-5

In these examples, the following materials were utilized:

| Material/Function | Designation |
|---|---|
| Moisture-curable SPU resin of Example 1 | SPU resin |
| Silanol-terminated diorganopolysiloxane of 3,000 cps @ | SDPS-1 |
| 25° C. | |
| Silanol-terminated diorganopolysiloxane of 30,000 cps | SDPS-2 |
| @ 25° C. | |
| Precipitated calcium carbonate (filler) | P-CaCO₃ |
| Surface-modified calcium carbonate (filler) | SM-CaCO₃ |
| Titanium dioxide (pigment) | TiO₂ |
| Fumed silica (thixotropic agent) | F-Sil |
| N-beta-(aminoethyl)-gamma-aminopropyl- | Silane A |
| trimethoxysilane (adhesion promoter) | |
| Tris-[3-(trimethoxysilyl)propyl]isocyanurate (adhesion | Isocyanurate |
| promoter) | |
| tetra-N-propylsilicate (crosslinker for SDPS) | NPS |
| methyltrimethoxysilane (moisture | Silane B |
| scavenger/crosslinker) | |
| Ciba-Geigy Tinuvin 213 | UV Stabilizer |
| Ciba-Geigy Tinuvin 622L | UV Stabilizer |
| Dibutyltin oxide (condensation catalyst) | DBTO |

The following general procedures were used, employing the above materials, to prepare the two-part curable compositions of Examples 2-5 and the one-part curable composition of Comparative Example 1:

A. Two-part Curable Compositions (Examples 2-5)

P-CaCO₃, SM-CaCO₃ and F-Sil were dried in an oven at 120° C. for at least 12 hours prior to use.

The first part of each two-part curable composition was prepared by mixing P-CaCO₃, diisodecylphthalate plasticizer, F-Sil, TiO₂, on a Speed Mixer DAC 400 FV at 2,000 rpm followed by sequential addition of SM-CaCO₃, SPU resin, antioxidant, UV stabilizer, Silane A, isocyanurate and NPS in the amounts indicated in Table 1 until a thoroughly blended mixture was obtained.

The second part of each two-part curable composition was prepared by mixing SDPS-1, SDPS-2 and P-CaCO₃ in the amounts indicated below in Table 1 on the Speed Mixer at 2000 rpm for about two minutes followed by additional DBTO condensation catalyst. The mixture was then blended on the Speed Mixer until a substantially homogeneous mixture was obtained.

B. One-part Curable Composition (Comparative Example 1)

The one-part curable composition was prepared as in the first part of the two-part curable composition described above but without NPS and with DBTO condensation catalyst being added last.

The above two-part curable compositions were blended on the Speed Mixer for 1-2 minutes then cast into films for mechanical testing and weatherability. Both the cast films and the one-part curable composition, also provided as a cast film were cured under controlled condition:

TABLE 1
Formulations of Curable Compositions

| | Example 2 | | Example 3 | | Example 4 | | Example 5 | | Comparative |
|---|---|---|---|---|---|---|---|---|---|
| | First | Second | First | Second | First | Second | First | Second | Example 1 |
| SPUR | Part | Part | Part | Part | Part | Part | Part | Part | One part Only |
| SPU resin | 65.6 | | 63.2 | | 80.2 | | 80.2 | | 100 |
| SDPS-1 | | 18.5 | | 18.4 | | 10.92 | | 10.92 | |
| SDPS-2 | | 15.9 | | 18.4 | | 8.88 | | 8.88 | |
| Plasticizer | 53 | | 53 | | 53 | | 79 | | 86.1 |
| P-CaCO3 | 104 | 35 | 104 | 35 | 119 | 20 | 119 | 20 | 140 |
| SM- | 94 | | 94 | | 94 | | 94 | | 95 |
| CaCO3 | | | | | | | | | |
| F-Sil | 3.3 | | 4.8 | | 4.8 | | 4.8 | | 4.8 |
| TiO2 | 2 | | 2 | | 2 | | 2 | | 2 |
| Anti- | 1.3 | | 0.5 | | 0.5 | | 0.54 | | 0.54 |
| oxidant | | | | | | | | | |
| UV | 1.3 | | 0.5 | | 0.5 | | 0.54 | | 0.54 |
| Stabilizer | | | | | | | | | |
| Silane A | 2.6 | | 5.3 | | 4.5 | | 2.7 | | 4.6 |
| Isocyanurate | 4.2 | | 1.3 | | 1.7 | | 0.6 | | 1.4 |
| NPS | 3.9 | | 3.9 | | | | 1.3 | | |
| Silane B | | | | | 3.9 | | 1.3 | | 4.1 |
| DBTO | | 1.3 | | 1.3 | | 1.3 | | 1.07 | 1.08 |

The results of the mechanical and weatherability tests carried out on the cured films were as follows:

TABLE 2
Experimental Results

| | | | | | Comparative |
|---|---|---|---|---|---|
| | Example 2 | Example 3 | Example 4 | Example 5 | Example 1 |
| Tensile Stress | 213 | 187 | 254 | 219 | 285 |
| (psi) | | | | | |
| Young's | 442 | 239 | 416 | 304 | 511 |
| Modulus (psi) | | | | | |
| Elongation % | 94 | 112 | 125 | 124 | 126 |
| Hardness | 47 | 43 | 46 | 43 | 55 |
| Shore A | | | | | |
| After aging in | 12 | 12 | 10 | 9 | 15 |
| a QUV | | | | | |
| weatherability | | | | | |
| apparatus for | | | | | |
| 4400 hrs | | | | | |
| b value | | | | | |
| Visual | Light beige, | Light beige, | Light beige, | Light beige, | Beige in |
| Appearance | less chalky | less chalky | less chalky | slightly | color, chalky |
| | | | | chalky | |

As these data show, the cured resin mixtures of the invention (Examples 2-5), while inferior in tensile strength, Young's Modulus and percent elongation compared with the cured resin of Comparative Example 1, nevertheless demonstrated acceptable values for each of these properties owing, it is believed, to their cured SPUR resin content. However, the cured resins of the invention significantly out-performed the resin of Comparative Example 1 in weatherability, a property believed to be attributable to the crosslinked polysiloxane content of the resins.

While the process of the invention has been described with reference to certain embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out the process of the invention but that the invention will include all embodiments falling within the scope of the appended claims.

What is claimed is:

1. A two-part curable composition which is stable during storage as two parts and on their combination cures to provide a substantially uniform polyurethane-polysiloxane resin mixture, the composition comprising:
a) a substantially moisture-free first part comprising moisture-curable silylated polyurethane resin and crosslinker for the crosslinking of silanol-terminated diorganopolysiloxane;
b) a second part comprising silanol-terminated diorganopolysiloxane;
c) a condensation catalyst in the first and/or second part; and, optionally,
d) at least one additional component selected from the group consisting of alkyl-terminated diorganopolysiloxane, filler, UV stabilizer, antioxidant, adhesion promoter, cure accelerator, thixotropic agent, moisture scavenger, pigment, dye, surfactant, solvent and biocide, the additional component being present in the first part and/or second part, whichever part(s) the component is compatible therewith.

2. The two-part curable composition of claim 1 wherein the silylated polyurethane resin is obtained by the reaction of isocyanate-terminated polyether polyol prepolymer with at least one silane selected from the group consisting of mercaptosilane and aminosilane.

3. The two-part curable composition of claim 2 wherein the isocyanate-terminated polyether polyol prepolymer is obtained by the reaction of polyether diol with a molar excess of diisocyanate.

4. The two-part composition of claim 3 wherein the polyether diol possesses a number average molecular weight of at least about 1,000 and the diisocyanate is at least one member of the group consisting of diphenylmethane diisocyanate, polymethylene polyphenylisocyanate, paraphenylene diisocyanate, naphthylene diisocyanate, liquid carbodiimide-modified diphenylmethane diisocyanate, isophorone diisocyanate, dicyclohexylmethane-4,4′-diisocyanate,toluene diisocyanate, 2,6-TDI isomer, aliphatic polyisocyanate, aromatic polyisocyanate and mixture thereof.

5. The two-part curable composition of claim 2 wherein the silane possesses the general formula:
X—R¹—Si(R²)ₓ(OR³)₃₋ₓ
wherein X is an active hydrogen-containing group that is reactive for isocyanate, R¹ is a divalent hydrocarbon group of up to 12 carbon atoms, optionally containing one or more heteroatoms, each R² is the same or different monovalent hydrocarbon group of up to 8 carbon atoms, each R³ is the same or different alkyl group of up to 6 carbon atoms and x is 0, 1 or 2.

6. The two-part curable composition of claim 5 wherein in the silane, X is —SH or —NHR⁴ in which R⁴ is H, a monovalent hydrocarbon group of up to 8 carbon atoms or —R⁵—Si(R⁶)_{y}(OR⁷)_{3-y} in which R⁵is a divalent hydrocarbon group of up to 12 carbon atoms, R⁶ is a monovalent hydrocarbon group of up to 8 carbon atoms, R⁷ is a monovalent hydrocarbon group of up to 6 carbon atoms and y is 0, 1 or 2.

7. The two-part curable composition of claim 6 wherein in the silane, X is —SH or —NHR⁴ in which R⁴ is H or a monovalent hydrocarbon radical of up to 8 carbon atoms, R¹ possesses up to 8 carbon atoms, R³ is the same or different alkyl group of up to 4 carbon atoms and x is 0.

8. The two-part curable composition of claim 2 wherein the silane is at least one member selected from the group consisting of 2-mercaptoethyl trimethoxysilane, 3-mercaptopropyl trimethoxysilane, 2-mercaptopropyl triethoxysilane, 3-mercaptopropyl triethoxysilane, 2-mercaptoethyl tripropoxysilane, 2-mercaptoethyl tri sec-butoxysilane, 3-mercaptopropyl tri-t-butoxysilane, 3-mercaptopropyl triisopropoxysilane, 3-mercaptopropyl trioctoxysilane, 2-mercaptoethyl tri-2′-ethylhexoxysilane, 2-mercaptoethyl dimethoxy ethoxysilane, 3-mercaptopropyl methoxyethoxypropoxysilane, 3-mercaptopropyl dimethoxy methylsilane, 3-mercaptopropyl methoxy dimethylsilane, 3-mercaptopropyl ethoxy dimethylsilane, 3-mercaptopropyl diethoxy methylsilane, 3-mercaptopropyl cyclohexoxy dimethyl silane, 4-mercaptobutyl trimethoxysilane, 3-mercapto-3-methylpropyltrimethoxysilane, 3-mercapto-3-methylpropyl-tripropoxysilane, 3-mercapto-3-ethylpropyl-dimethoxy methylsilane, 3-mercapto-2-methylpropyl trimethoxysilane, 3-mercapto-2-methylpropyl dimethoxy phenylsilane, 3-mercaptocyclohexyl-trimethoxysilane, 12-mercaptododecyl trimethoxy silane, 12-mercaptododecyl triethoxy silane, 18-mercaptooctadecyl trimethoxysilane, 18-mercaptooctadecyl methoxydimethylsilane, 2-mercapto-2-methylethyl-tripropoxysilane, 2-mercapto-2-methylethyl-trioctoxysilane, 2-mercaptophenyl trimethoxysilane, 2-mercaptophenyl triethoxysilane, 2-mercaptotolyl trimethoxysilane, 2-mercaptotolyl triethoxysilane, 1-mercaptomethyltolyl trimethoxysilane, 1-mercaptomethyltolyl triethoxysilane, 2-mercaptoethylphenyl trimethoxysilane, 2-mercaptoethyiphenyl triethoxysilane, 2-mercaptoethyltolyl trimethoxysilane, 2-mercaptoethyltolyl triethoxysilane, 3-mercaptopropylphenyl trimethoxysilane, 3-mercaptopropylphenyl triethoxysilane, 3-aminopropyltrimethoxysilane, 3-aminopropyltriethoxysilane, 3-aminobutyltriethoxysilane, N-methyl-3-amino-2-methylpropyltrimethoxysilane, N-ethyl-3-amino-2-methylpropyltrimethoxysilane, N-ethyl-3-amino-2-methylpropyldiethoxymethylsilane, N-ethyl-3-amino-2-methylpropyltriethoxysilane, N-ethyl-3-amino-2-methylpropylmethyldimethoxysilane, N-butyl-3-amino-2-methylpropyltrimethoxysilane, 3-(N-methyl-2-amino-1-methyl-1-ethoxy)-propyltrimethoxysilane, N-ethyl-4-amino-3,3-dimethylbutyldimethoxymethylsilane, N-ethyl-4-amino-3,3-dimethylbutyltrimethoxysilane, N-(cyclohexyl)-3-aminopropyltrimethoxysilane, N-(2-aminoethyl)-3-aminopropyltrimethoxysilane, N-(2-aminoethyl)-3-aminopropyltriethoxysilane, N-(2-aminoethyl)-3-aminopropylmethyl-dimethoxysilane, aminopropyltriethoxysilane, bis-(3-trimethoxysilyl-2-methylpropyl)amine and N-(3′-trimethoxysilylpropyl)-3-amino-2-methylpropyltrimethoxysilane.

9. The two-part curable composition of claim 1 wherein the silylated polyurethane resin is obtained by the reaction of hydroxyl-terminated polyether polyol with isocyanatosilane.

10. The two-part curable composition of claim 9 wherein the hydroxyl-terminated polyurethane prepolymer is obtained by the reaction of a diisocyanate and a molar excess of polyether diol.

11. The two-part curable composition of claim 10 wherein the polyether diol possesses a number average molecular weight of at least about 1,000 and the diisocyanate is at least one member of the group consisting of diphenylmethane diisocyanate, polymethylene polyphenylisocyanate, paraphenylene diisocyanate, naphthylene diisocyanate, liquid carbodiimide-modified diphenylmethane diisocyanate, isophorone diisocyanate, dicyclohexylmethane-4,4′-diisocyanate,toluene diisocyanate, 2,6-TDI isomer, aliphatic polyisocyanate, aromatic polyisocyanate and mixture thereof.

12. The two-part curable composition of claim 9 wherein the isocyanatosilane possesses the general formula: 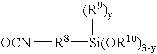
wherein R⁸ is an alkylene group of up to 12 carbon atoms, each R⁹ is the same or different alkyl or aryl group of up to 8 carbon atoms, each R¹⁰ is the same or different alkyl group of up to 6 carbon atoms and y is 0, 1 or 2.

13. The two-part curable composition of claim 12 wherein in the isocyanatosilane, R⁹ possesses 1 to 4 carbon atoms, each R¹⁰ is the same or different methyl, ethyl, propyl or isopropyl group and y is 0.

14. The two-part curable composition of claim 9 wherein the isocyanatosilane is selected from the group consisting of isocyanatopropyltrimethoxysilane, isocyanatoisopropyltrimethoxysilane, isocyanato-n-butyltrimethoxysilane, isocyanato-t-butyltrimethoxysilane, isocyanatopropyltriethoxysilane, isocyanatoisopropyltriethoxysilane, isocyanato-n-butyltriethoxysilane and isocyanato-t-butyltriethoxysilane.

15. The two-part curable composition of claim 1 wherein the silanol-terminated diorganopolysiloxane is of the general formula:
MₐD_{b}D′_{c}
wherein a is 2, b is equal to or greater than 1 and c is zero or a positive value where M=(HO)_{3-x-y}R¹⁵ₓR¹⁶_{y}SiO_{1/2}; with the subscript x being 0, 1 or 2 and the subscript y being either 0 or 1, subject to the limitation that x+y is less than or equal to 2, where R¹⁵ and R¹⁶ are independently chosen monovalent C₁ to C₆₀ hydrocarbon radicals; where
D=R¹⁷R¹⁸SiO_{1/2};
where R¹⁷ and R¹⁸ are independently chosen monovalent C₁ to C₆₀ hydrocarbon radicals; where
D′=R¹⁹R²⁰SiO_{2/2};
where R¹⁹ and R²⁰ are independently chosen monovalent hydrocarbon radicals of up to about 60 carbon atoms.

16. The two-part curable composition of claim 1 wherein the crosslinker is an alkylsilicate.

17. The two-part curable composition of claim 2 wherein the crosslinker is an alkylsilicate.

18. The two-part curable composition of claim 9 wherein the crosslinker is an alkylsilicate.

19. The two-part curable composition of claim 1 wherein the silanol-terminated diorganopolysiloxane possesses a viscosity of from about 1,000 to about 200,000 cps at 25° C.

20. The two-part composition of claim 2 wherein the silanol-terminated diorganopolysiloxane possesses a viscosity of from about 1,000 to about 200,000 cps at 25° C.

21. The two-part composition of claim 9 wherein the silanol-terminated diorganopolysiloxane possesses a viscosity of from about 1,000 to about 200,000 cps at 25° C.

22. The two-part composition of claim 1 wherein filler, where present, is in the first and/or second part; U.V. stabilizer, where present, is in the first and/or second part; antioxidant, where present, is in the first and/or second part; adhesion promoter, where present, is in the first part; cure accelerator, where present, is in the first part; thixotropic agent, where present, is in the first and/or second part; moisture scavenger, where present, is in the first part; pigment, where present, is in the first and/or second part; dye, where present, is in the first and/or second part; surfactant, where present, is in the first and/or second part; solvent, where present is in the first and/or second part; and, biocide, where present, is in the second part.

23. The two-part composition of claim 2 wherein filler, where present, is in the first and/or second part; U.V. stabilizer, where present, is in the first and/or second part; antioxidant, where present, is in the first and/or second part; adhesion promoter, where present, is in the first part; cure accelerator, where present, is in the first part; thixotropic agent, where present, is in the first and/or second part; moisture scavenger, where present, is in the first part; pigment, where present, is in the first and/or second part; dye, where present, is in the first and/or second part; surfactant, where present, is in the first and/or second part; solvent, where present is in the first and/or second part; and, biocide, where present, is in the second part.

24. The two-part composition of claim 9 wherein filler, where present, is in the first and/or second part; U.V. stabilizer, where present, is in the first and/or second part; antioxidant, where present, is in the first and/or second part; adhesion promoter, where present, is in the first part; cure accelerator, where present, is in the first part; thixotropic agent, where present, is in the first and/or second part; moisture scavenger, where present, is in the first part; pigment, where present, is in the first and/or second part; dye, where present, is in the first and/or second part; surfactant, where present, is in the first and/or second part; solvent, where present is in the first and/or second part; and, biocide, where present, is in the second part.

25. The substantially uniform polyurethane-polysiloxane resin mixture resulting from the curing of the combination of the first and second parts of the two-part curable composition of claim 1.

26. The substantially uniform polyurethane-polysiloxane resin mixture resulting from the curing of the combination of the first and second parts of the two-part curable composition of claim 2.

27. The substantially uniform polyurethane-polysiloxane resin mixture resulting from the curing of the combination of the first and second parts of the two-part curable composition of claim 9.
